(19) United States
(12) Patent Application Publication
(10) Pub. No.: US 2025/0207946 A1
(43) Pub. Date: Jun. 26, 2025

(54) ENCODER

(71) Applicant: FUJI ELECTRIC CO., LTD., Kanagawa (JP)

(72) Inventor: Akira MORITA, Tokyo (JP)

(21) Appl. No.: 18/928,748

(22) Filed: Oct. 28, 2024

(30) Foreign Application Priority Data
Dec. 26, 2023 (JP) 2023-219493

(51) Int. Cl. G01D 5/14; G01D 5/245

(52) U.S. Cl. CPC G01D 5/145; G01D 5/245

(57) ABSTRACT

An encoder includes a power generation element, magnetic sensors, a first magnet which is rotationally symmetric, rotates on a rotating shaft, and is provided near the magnetic sensors, and a second magnet which is rotationally symmetric, rotates on the rotating shaft, is provided near the power generation element, and is continuously provided in a circumferential direction.

### CROSS-REFERENCE TO RELATED APPLICATIONS

The present application is based on and claims priority to Japanese patent application No. 2023-219493 filed on Dec. 26, 2023, with the Japanese Patent Office, the entire contents of which are hereby incorporated by reference.

### BACKGROUND OF THE INVENTION

### 1. Field of the Invention

This disclosure relates to encoders.

### 2. Description of the Related Art

Patent Literature (PTL) 1 discloses a rotation detector for detecting an amount of rotation of a rotating shaft of a motor. PTL 1 discloses that the rotation detector includes a power generating magnet which is rotationally integrally mounted on the rotating shaft and has four or more magnetic poles in a circumferential direction, at least one power generation element consisting of a magnetic sensing section and an induction coil, and a first magnetic sensor and a second magnetic sensor. PTL 1 also discloses that the rotation detector further includes a magnetic flux control member whose position changes with the power generating magnet due to rotation of the rotating shaft and which may generate an excitation voltage in at least one of the first magnetic sensor and the second magnetic sensor. PTL 1 discloses that the rotation detector drives the first magnetic sensor and the second magnetic sensor with electric power generated by the power generation element by rotation of the power generating magnet.

As a battery-less encoder, there is a case where a power generation element that generates power using Barkhausen characteristics is used. The power generation element is required to improve power generation efficiency.

The present disclosure provides a technique to enhance power generation efficiency in an encoder.

### CITATION LIST

### Patent Literature

[PTL 1] International Publication No. WO 2021/044758

### SUMMARY OF THE INVENTION

An encoder includes a power generation element, magnetic sensors, a first magnet which is rotationally symmetric, rotates on a rotating shaft, and is provided near the magnetic sensors, and a second magnet which is rotationally symmetric, rotates on the rotating shaft, is provided near the power generation element, and is continuously provided in a circumferential direction.

According to the encoder of the present disclosure, power generation efficiency can be increased.

### BRIEF DESCRIPTION OF THE DRAWINGS

FIG. 1 is a drawing describing a servomotor system using an encoder according to a first embodiment;

FIG. 2 is a drawing describing a configuration of a servomotor using the encoder according to the first embodiment;

FIG. 3 is a drawing describing a circuit configuration of the encoder according to the first embodiment;

FIG. 4 is a drawing describing the circuit configuration of the encoder according to the first embodiment;

FIG. 5 is a drawing describing the circuit configuration of the encoder according to the first embodiment;

FIG. 6 is a plan view describing a configuration of magnets in the encoder according to the first embodiment;

FIG. 7 is a cross-sectional view describing a configuration of the magnets in the encoder according to the first embodiment;

FIG. 8 is a drawing describing a signal waveform in the encoder according the first embodiment;

FIG. 9 is a drawing describing the signal waveform in the encoder according to the first embodiment;

FIG. 10 is a cross-sectional view describing a configuration of the encoder according to the first embodiment;

FIG. 11 is a plan view describing the configuration of a magnet in the encoder according to a second embodiment; and

FIG. 12 is a plan view describing the configuration of the magnets in the encoder according to a third embodiment.

### DESCRIPTION OF THE PREFERRED EMBODIMENTS

In the following, embodiments of the present invention will be described with reference to the accompanying drawings. In the description and drawings according to embodiments, the same constituent elements are denoted with the same reference numerals, and redundant description thereabout may be omitted. In addition, for ease of understanding, the scale of each part in the drawings may differ from the actual scale.

### First Embodiment

An encoder according to the first embodiment will be described. The encoder according to the first embodiment includes a power generation element, magnetic sensors, a rotationally symmetric first magnet rotating around a rotating shaft and provided near the magnetic sensors, and a rotationally symmetric second magnet rotating around the rotating shaft and provided near the power generation element and continuously provided in the circumferential direction.

### <Servomotor System>

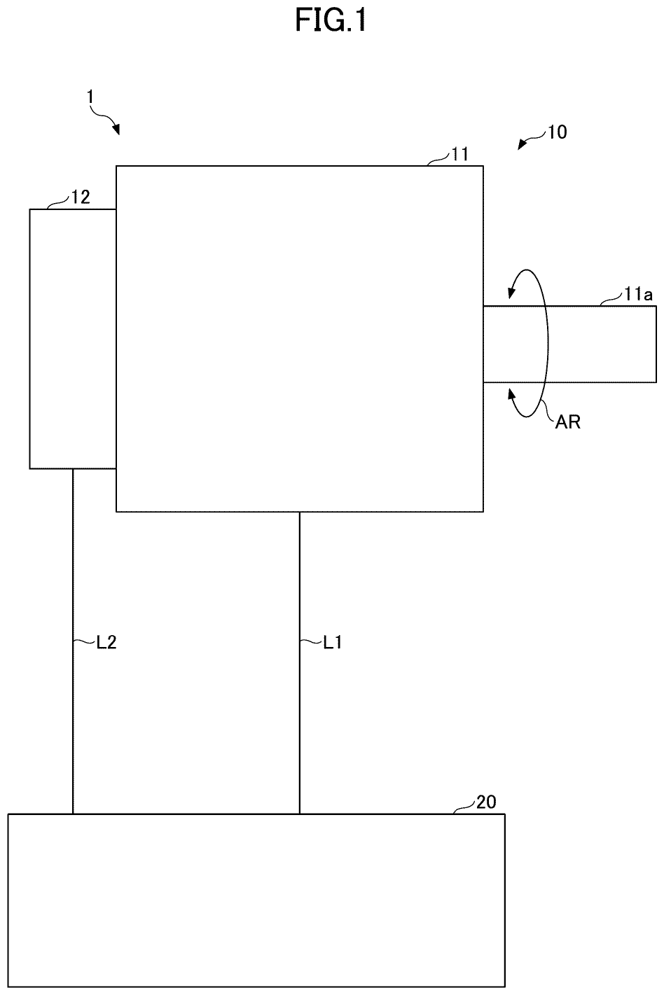

First, a servomotor system using the encoder according to the present embodiment will be described. FIG. 1 is a drawing describing the servomotor system 1 using an encoder 12 as an example of the encoder according to the first embodiment.

The servomotor system 1 includes a servomotor 10 and a servocontroller 20. The servocontroller 20 acquires from the servomotor 10 at least one of position information and rotation information of the rotating shaft 11a. The servocontroller 20 controls the servomotor 10 using at least one of an acquired position information and rotation information.

The servomotor 10 includes a motor 11 and the encoder 12. The motor 11 is connected to the servocontroller 20 via a wire L1. The encoder 12 is connected to the servocontroller 20 via a wire L2.

The motor 11 rotates the rotating shaft 11a in the direction of an arrow AR based on a command from the servocontroller 20. Specifically, the motor 11 rotates the rotating shaft 11a in a direction of the arrow AR based on electric power supplied from the servocontroller 20. The servocontroller 20 controls the motor 11 by supplying controlled electric power via the wire L1. The motor 11 is, for example, an AC (alternating current) motor, a DC (direct current) motor, or the like.

The encoder 12 detects a variation in a magnetic field and detects at least one of position information and rotation information of an object such as the rotating shaft 11a of the motor 11. The encoder 12 outputs at least one of the detected position information and rotation information to the servocontroller 20 via the wire L2. The position information of the rotating shaft 11a is, for example, an angle in the rotational direction of the rotating shaft 11a. The rotation information of the rotating shaft 11a is, for example, a rotation speed of the rotating shaft 11a or a number of rotation times indicating the number of rotations of the rotating shaft 11a from a predetermined point in time.

### <Servomotor 10>

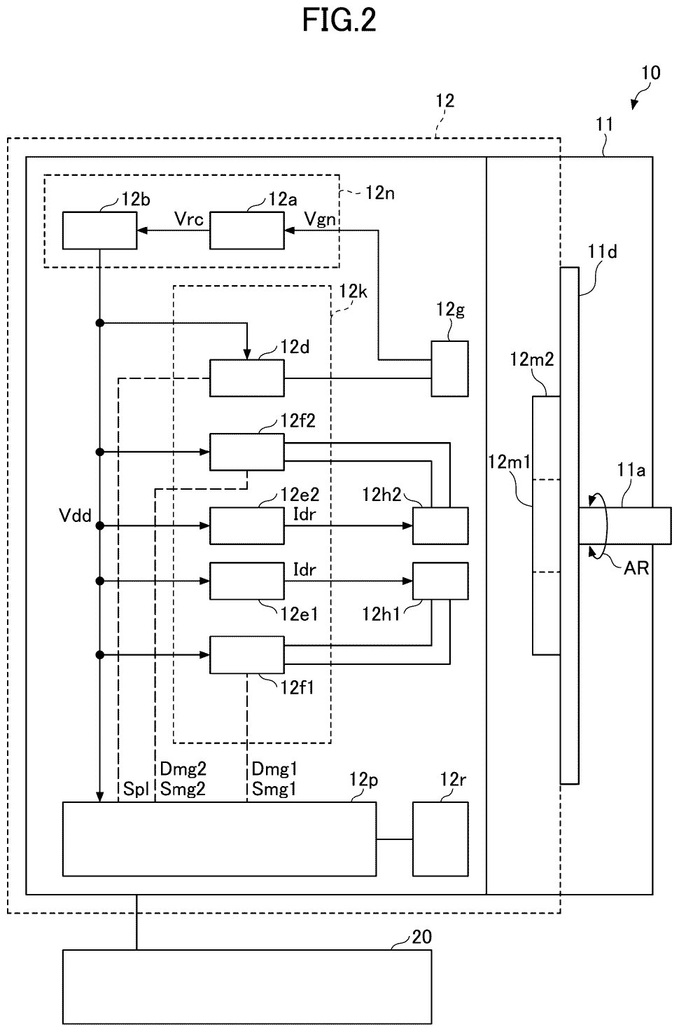

Subsequently, the configuration of the servomotor 10 using the encoder 12, which is one example of the encoder according to the first embodiment, will be described. FIG. 2 is a drawing describing the configuration of the servomotor 10 using the encoder 12, which is one example of the encoder according to the first embodiment. Lines with arrows indicate a flow of power or current supply.

### [Motor 11]

The motor 11 rotates the rotating shaft 11a. The motor 11 includes well-known elements such as bearings for supporting the rotating shaft 11a, windings constituting a stator to rotate the rotating shaft 11a, an iron core, and permanent magnets constituting a rotor, but a description thereof is here. The motor 11 includes a disk 11d omitted adjacent to the encoder 12 of the rotating shaft 11a. As described later, a first magnet 12m1 provided t r symmetrically with respect to the rotating shaft 11a and a second magnet 12m2 provided continuously in the circumferential direction of the rotating shaft 11a are mounted on the disk 11d. The first magnet 12m1 and the second magnet 12m2 rotate about the rotating shaft 11a.

The disk 11d is fixed to the rotating shaft 11a. The disk 11d rotates together with the rotating shaft 11a as the rotating shaft 11a rotates in the direction of arrow AR. The first magnet 12m1 and the second magnet 12m2 are fixed to the surface of a disk 11d facing the encoder 12.

Each of the first magnet 12m1 and the second magnet 12m2 is a permanent magnet formed of neodymium or the like. When the first magnet 12m1 and the second magnet 12m2 rotate together with the disk 11d, the magnetic field on the encoder 12 side changes.

The first magnet 12m1 is provided so as to have an N pole and an S pole in a direction parallel to the surface of the disk 11d. The first magnet 12m1 generates a magnetic field detected by the first magnetic sensor 12h1 and the second magnetic sensor 12h2, respectively.

The second magnet 12m2 generates a magnetic field that causes the power generation element 12g to generate power. The second magnet 12m2 is provided continuously in the circumferential direction of the rotating shaft 11a. Details of the second magnet 12m2 will be described later.

### [Encoder 12]

The encoder 12 will be described. The encoder 12 detects at least one of the position information and the rotation information of the rotating shaft 11a by the magnetic field changed by a rotation of the first magnet 12m1 and the second magnet 12m2. The encoder 12 is an absolute encoder. The encoder 12 operates as at least a multi-turn encoder. That is, the encoder 12 counts the number of rotations of the rotating shaft 11a. The encoder 12 generates electric power required to operate the encoder 12 by the magnetic field changed by the rotation of the second magnet 12m2.

The encoder 12 includes the power generation element 12g, a rectifier circuit 12a, a regulated power supply circuit 12b, and a polarity detection circuit 12d. The encoder 12 also includes a drive circuit 12e1 and a drive circuit 12e2, the first magnetic sensor 12h1 and the second magnetic sensor 12h2, a signal processing circuit 12f1 and a signal processing circuit 12f2, a control circuit 12p, and a storage 12r. The encoder 12 also includes a first magnet 12m1 and a second magnet 12m2. The rectifier circuit 12a and the regulated power supply circuit 12b are collectively referred to as a power supply circuit 12n. The polarity detection circuit 12d, the drive circuit 12e1, the drive circuit 12e2, the signal processing circuit 12f1, and the signal processing circuit 12f2 are collectively referred to as a rotation detection circuit 12k.

The encoder 12 includes the power generation element 12g that generates power by a change in magnetic flux caused by movement, and the first magnetic sensor 12h1 and the second magnetic sensor 12h2 that measure the magnetic field. The power generation element 12g, the first magnetic sensor 12h1, and the second magnetic sensor 12h2 are provided on the motor 11 side of the encoder 12 so as to be easily affected by magnetic fields generated by the first magnet 12m1 and the second magnet 12m2.

[Power Generation Element 12g]

The power generation element 12g is an element that generates power by converting magnetic energy into electric pulses. The power generation element 12g is a power generation element that generates power using Barkhausen characteristics. The power generation element 12g is, for example, a Wiegand wire that is an EHG (Energy Harvest Generator).

The power generation element 12g includes a hard core and a soft layer wound around the hard core. The hard core is formed of a material having a large coercive force. The soft layer is formed of a material having a small coercive force. The power generation element 12g generates a power generation pulse when the direction of the external magnetic field is reversed.

For example, the Wiegand wire generates an electric pulse in proximity to a zero point where the external magnetic field is reversed without depending on a rate of change of the external magnetic flux. Therefore, the Wiegand wire generates a constant electric power regardless of a rotational speed of the rotating shaft 11a. The Wiegand wire generates a stable electric pulse (voltage pulse) even when the magnetic flux changes slowly due to low-speed rotation (movement). The Wiegand wire generates an electric pulse when the magnetic field is reversed.

By using an EHG in the power generation element 12g, the encoder 12 does not require a battery or an external power source. That is, the encoder 12 is a battery-less encoder. The Wiegand wire is suitable for use as the power generation element 12g of the encoder 12, which is the battery-less encoder, because it generates the constant electric power regardless of the rotational speed of the rotating shaft 11a, and because stable power generation waveforms can be obtained even at low speeds, in particular.

The power generation element 12g is not limited to a Wiegand wire, but may be any power generation element that generates power using Barkhausen characteristics.

The power generation element 12g generates power by a magnetic field generated by the second magnet 12m2.

[First Magnetic Sensor 12h1 and Second Magnetic Sensor 12h2]

Each of the first magnetic sensor 12h1 and the second magnetic sensor 12h2 detects a magnetic field. More specifically, each of the first magnetic sensor 12h1 and the second magnetic sensor 12h2 detects a magnetic field generated by the first magnet 12m1 described later.

Each of the first magnetic sensor 12h1 and the second magnetic sensor 12h2 is, for example, a Hall element. The Hall element detects a magnetic field across the semiconductor element through which the drive current flows. In the encoder 12, each of the first magnetic sensor 12h1 and the second magnetic sensor 12h2 mainly detects a magnetic field generated by the first magnet 12m1. The Hall element constituting each of the first magnetic sensor 12h1 and the second magnetic sensor 12h2 is composed of, for example, a semiconductor element such as indium antimonide (InSb) or gallium arsenide (GaAs). The Hall element outputs a drive current and a voltage proportional to the magnetic flux density across the drive current.

The first magnetic sensor 12h1 outputs a detection signal of a magnetic field to the signal processing circuit 12f1. The first magnetic sensor 12h1 is supplied with a constant current Idr from the drive circuit 12e1. The second magnetic sensor 12h2 outputs a detection signal of a magnetic field to the signal processing circuit 12f2. The second magnetic sensor 12h2 is supplied with a constant current Idr from the drive circuit 12e2.

The first magnetic sensor 12h1 is supplied with a current (constant current Idr) obtained by rectifying the electric power generated by the power generation element 12g by the rectifier circuit 12a and further converted to a constant current by the drive circuit 12e1. The second magnetic sensor 12h2 is supplied with a current (constant current Idr) obtained by rectifying the electric power generated by the power generation element 12g by the rectifier circuit 12a and further converted to a constant current by the drive circuit 12e2.

The second magnetic sensor 12h2 has a magnetic sensitivity direction that is 90 degrees out of phase with the first magnetic sensor 12h1. The encoder 12 has magnetic sensitivity directions that are mutually 90 degrees out of phase, owing to the first magnetic sensor 12h1 and the second magnetic sensor 12h2. In other words, the magnetic sensors (the first magnetic sensor 12h1 and the second magnetic sensor 12h2) in the encoder 12 have magnetic sensitivity directions that are 90 degrees out of phase with each other.

Although the encoder 12 has two magnetic sensors, the number of magnetic sensors is not limited to two. The encoder 12 may have three or more magnetic sensors. The measurement of a magnetic field is not limited to a Hall element as long as it is an element capable of detecting magnetism (magnetic detection element). For example, a magnetoresistive effect element or the like may be used as the magnetic sensor.

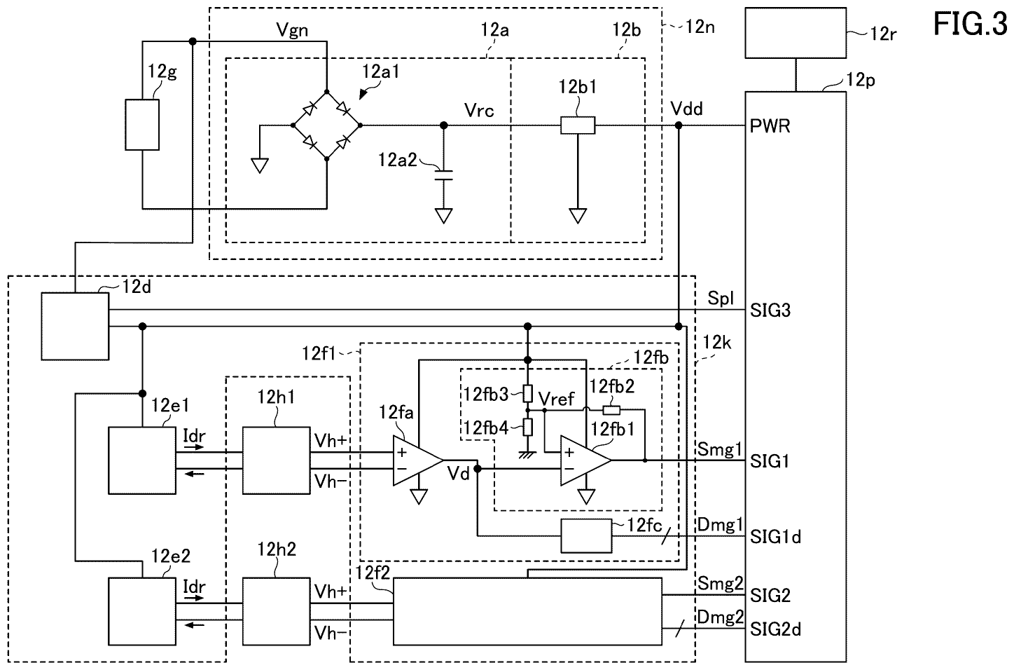

The circuit configuration of the encoder 12 will be described with reference to FIG. 3. FIG. 3 is a drawing describing the circuit configuration of the encoder 12 as one example of the encoder according to the present embodiment.

### [Rectifier Circuit 12A]

The rectifier circuit 12a rectifies the power generated by the power generation element 12g to generate a positive voltage. The rectifier circuit 12a includes a full-wave rectifier circuit 12a1 and a capacitor 12a2.

The full-wave rectifier circuit 12a1 rectifies the positive and negative pulses of the voltage Vgn generated by the power generation element 12g into positive pulses. The full-wave rectifier circuit 12a1 is what is called a diode bridge circuit. For example, when the power generation element 12g is a Wiegand wire, the power generation element 12g generates positive and negative pulses. The full-wave rectifier circuit 12a1 converts the positive and negative pulses generated by the power generation element 12g into positive pulses.

The capacitor 12a2 stores the electric power generated by the power generation element 12g. The capacitor 12a2 smooths the positive pulses generated by the full-wave rectifier circuit 12a1. The capacitor 12a2 is provided between the output terminal of the full-wave rectifier circuit 12a1 and the common potential. As the positive pulses are smoothed by the capacitor 12a2, the rectifier circuit 12a outputs the smoothed voltage Vrc.

[Regulated Power Supply Circuit 12b]

The regulated power supply circuit 12b sets the voltage output from the rectifier circuit 12a to a substantially constant voltage and outputs the same. The regulated power supply circuit 12b includes a regulator 12b1. The regulator 12b1 is, for example, an LDO (low dropout) regulator.

When a voltage of a predetermined magnitude is input, the regulated power supply circuit 12b outputs a substantially constant voltage Vdd.

[Polarity Detection Circuit 12d]

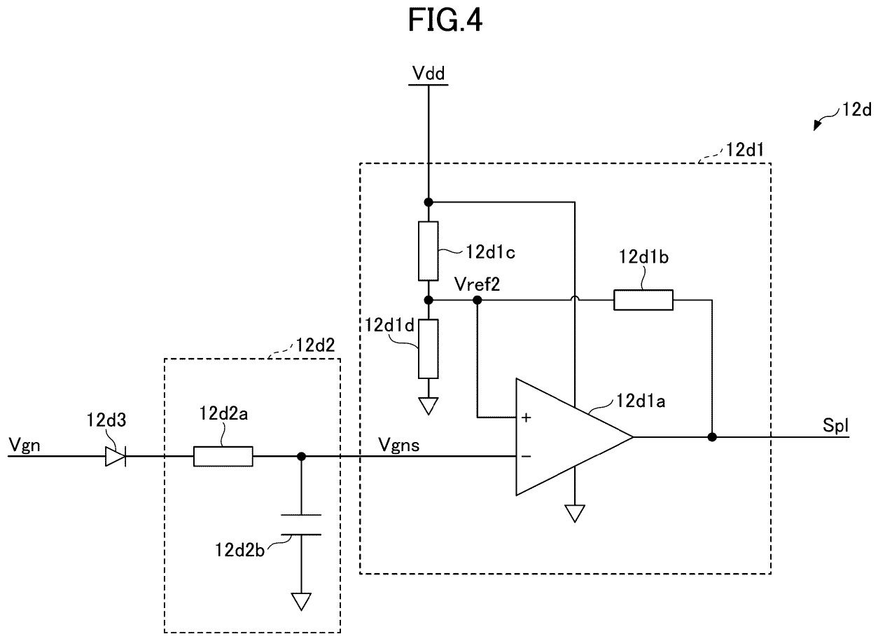

The polarity detection circuit 12d detects the polarity of the electric power generated by the power generation element 12g. FIG. 4 is a drawing describing the circuit configuration of the polarity detection circuit 12d in the encoder 12. The polarity detection circuit 12d includes a comparator 12d1, a filter circuit 12d2, and a diode 12d3. The diode 12d3 prevents the current from flowing from the polarity detection circuit 12d to the power generation element 12g. The filter circuit 12d2 is a low-pass filter including a resistor 12d2a and a capacitor 12d2b.

The comparator 12d1 compares the voltage Vgns with a reference potential (reference potential Vref2), and outputs the comparison result to the control circuit 12p. The comparator 12d1 is what is called a comparator. The comparator 12d1 includes a differential amplifier 12d1a, a resistor 12d1b, a resistor 12d1c, and a resistor 12d1d. The power of the voltage Vdd is supplied to the differential amplifier 12d1a from the regulated power supply circuit 12b. The differential amplifier 12d1a compares the voltage Vgns obtained by smoothing the voltage Vgn of the output of the power generation element 12g by the filter circuit 12d2 with the reference potential Vref2 generated by dividing the voltage Vdd by the resistor 12d1c and the resistor 12d1d. The differential amplifier 12d1a outputs the comparison result to the control circuit 12p as a polarity signal Spl, which is a voltage signal. The resistor 12d1b is a feedback resistor.

[Drive Circuit 12e1 and Drive Circuit 12e2]

The drive circuit 12e1 and the drive circuit 12e2 are what is called constant current circuits that supply a constant current Idr to the first magnetic sensor 12h1 and the second magnetic sensor 12h2, respectively. Each of the drive circuit 12e1 and the drive circuit 12e2 operates as a constant current source. The encoder 12 drives each of the first magnetic sensor 12h1 and the second magnetic sensor 12h2, which are Hall elements, with a constant current Idr.

The drive circuit 12e1 supplies drive power to the first magnetic sensor 12h1 so that a constant current flows as a drive current to the first magnetic sensor 12h1, which is a Hall element. The drive circuit 12e2 supplies drive power to the second magnetic sensor 12h2 so that a constant current flows as a drive current to the second magnetic sensor 12h2, which is a Hall element.

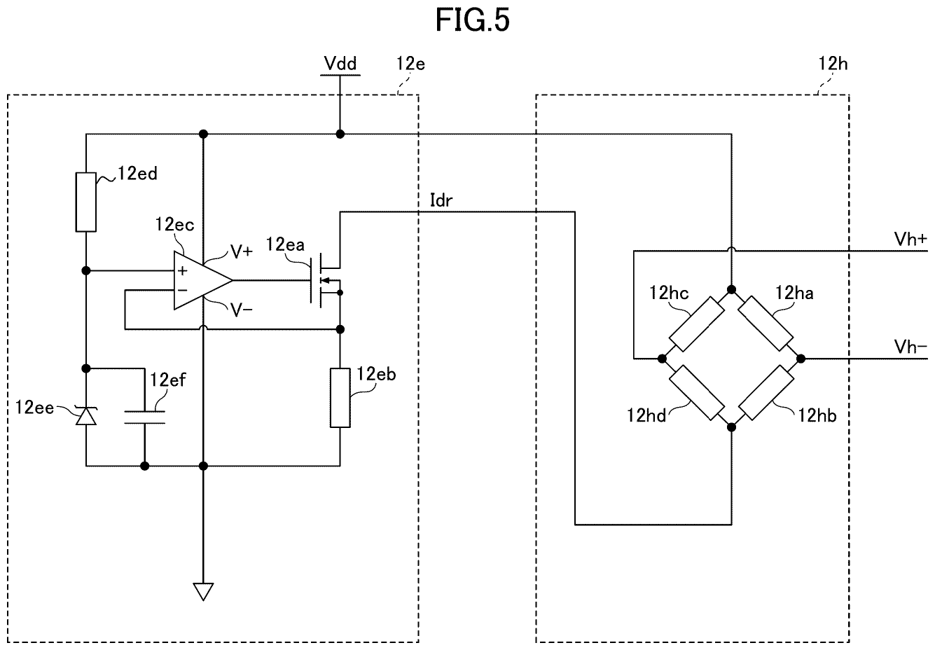

FIG. 5 is a drawing describing the circuit configuration of the drive circuit and the magnetic sensor in the encoder 12, which is one example of the encoder according to the present embodiment. Since the drive circuit 12e1 and the drive circuit 12e2 have the same circuit configuration, each of the drive circuit 12e1 and the drive circuit 12e2 will be described as a drive circuit 12e in FIG. 5. In FIG. 5, each of the first magnetic sensor 12h1 and the second magnetic sensor 12h2, which are Hall elements, is equivalently shown as a magnetic sensor 12h using a bridge circuit having a resistor 12ha, a resistor 12hb, a resistor 12hc, and a resistor 12hd.

The drive circuit 12e includes a transistor 12ea, a current detection resistor 12eb, and a differential amplifier 12ec. The drive circuit 12e includes a resistor 12ed, a Zener diode 12ee, and a capacitor 12ef.

The transistor 12ea is controlled so that a constant current flows through the magnetic sensor 12h. The output terminal of the differential amplifier 12ec is connected to the gate terminal of the transistor 12ea. The differential amplifier 12ec outputs a voltage based on the potential difference between a plus terminal and a minus terminal from the output terminal. The drive circuit 12e is controlled so that a constant current (constant current Idr) based on the voltage input to the plus terminal and the resistance value of the current detection resistor 12eb flows between the drain and the source of the transistor 12ea.

The magnetic sensor 12h is driven by the constant current Idr, and outputs a voltage Vh+ and a voltage Vh− proportional to the constant current Idr and the magnetic flux density across the magnetic sensor 12h.

The drive circuit 12e is driven by the voltage Vdd supplied from the regulated power supply circuit 12b.

[Signal Processing Circuit 12f1 and Signal Processing Circuit 12f2]

The signal processing circuit 12f1 and the signal processing circuit 12f2 process detection signals from the first magnetic sensor 12h1 and the second magnetic sensor 12h2, respectively, to detect the direction of the magnetic field of the first magnet 12m1. The signal processing circuit 12f1 and the signal processing circuit 12f2 output the intensity of the magnetic field of the first magnet 12m1 to the control circuit 12p based on detection signals from the first magnetic sensor 12h1 and the second magnetic sensor 12h2, respectively. The signal processing circuit 12f1 and the signal processing circuit 12f2 will be described with reference to FIG. 3. Since the signal processing circuit 12f1 and the signal processing circuit 12f2 have the same circuit configuration, FIG. 3 will be described with reference to the signal processing circuit 12f1.

The signal processing circuit 12f1 includes a differential amplifier 12fa, a comparator 12fb, and a quantizer 12fc.

### (Differential Amplifier 12Fa)

The differential amplifier 12fa outputs to the comparator 12fb a voltage Vd obtained by amplifying the potential difference between the voltage Vh+ and the voltage Vh-output from the magnetic sensor 12h. The power of the voltage Vdd is supplied to the differential amplifier 12fa from the regulated power supply circuit 12b.

### (Comparator 12fb)

The comparator 12fb compares the voltage Vd output from the differential amplifier 12fa with a reference potential (reference potential Vref), and outputs the comparison result to the control circuit 12p. The comparator 12fb is what is called a comparator. The comparator 12fb includes a differential amplifier 12fb1, a resistor 12fb2, a resistor 12fb3, a 12fb4. The and resistor differential amplifier 12fb1 is supplied with power of the voltage Vdd from the regulated power supply circuit 12b. The differential amplifier 12fb1 compares the voltage Vd of the output of the differential amplifier with 12fa a reference potential Vref generated by dividing the voltage Vdd by the resistors 12fb3 and 12fb4, and outputs the comparison result to the control circuit 12p as a magnetic pole signal Smg1, which is a voltage signal. The resistor 12fb2 is a feedback resistor.

### (Quantizer 12fc)

The quantizer 12fc quantizes the voltage Vd output from the differential amplifier 12fa, and outputs the quantized result to the control circuit 12p. The quantizer 12fc is what is called an analog-to-digital converter (AD converter). The quantizer 12fc quantizes the voltage Vd output from the differential amplifier 12fa, and outputs, for example, a digital value of eight bits as a magnetic field strength signal Dmg1 to the control circuit 12p.

[Control Circuit 12p]

The control circuit 12p calculates at least one position information such as the rotational of position and the number of rotations of the rotating shaft 11a of the motor 11 and rotation information based on inputs from the polarity detection circuit 12d, the signal processing circuit 12f1, and the signal processing circuit 12f2. The control circuit 12p records at least one of the detected position information and rotation information of the rotating shaft 11a of the motor 11 and transmits the information to an external control system such as the servocontroller 20.

The control circuit 12p is, for example, a microcomputer, an ASIC (application specific integrated circuit), or the like. The control circuit 12p may be, for example, an FPGA (Field-Programmable Gate Array), a PLD (Programmable Logic Device), or the like.

The control circuit 12p is connected to an external storage 12r. The control circuit 12p may include a nonvolatile memory such as a ferroelectric memory in place of the external storage 12r.

The control circuit 12p includes at least a terminal PWR, a terminal SIG1, a terminal array SIG1d, a terminal SIG2, a terminal array SIG2d, and a terminal SIG3.

The terminal PWR of the control circuit 12p is a terminal to which a positive power supply is supplied. The terminal PWR is supplied with a power of voltage Vdd from the regulated power supply circuit 12b. The control circuit 12p operates when power is supplied to the terminal PWR.

Each of the terminals SIG1, SIG2, and SIG3 of the control circuit 12p is a terminal to which a signal is input from the outside. The terminal array SIG1d and the terminal array SIG2d of the control circuit 12p are terminal arrays to which a signal of a plurality of bits is input from the outside.

The terminal SIG1 is connected to the signal processing circuit 12f1. A magnetic pole signal Smg1, which is a detection result detected by the signal processing circuit 12f1, is input from the terminal SIG1. The magnetic pole signal Smg1 is a signal indicating the direction of the magnetic field detected by the first magnetic sensor 12h1. The terminal SIG2 is connected to the signal processing circuit 12f2. A magnetic pole signal Smg2, which is a detection result detected by the signal processing circuit 12f2, is input from the terminal SIG2. The magnetic pole signal Smg2 is a signal indicating the direction of the magnetic field detected by the second magnetic sensor 12h2.

The terminal array SIG1d is connected to the signal processing circuit 12f1. A magnetic field strength signal Dmg1, which is a detection result detected by the signal processing circuit 12f1, is input from the terminal array SIG1d. The magnetic field strength signal Dmg1 is a signal indicating the intensity of the magnetic field detected by the first magnetic sensor 12h1. The terminal array SIG2d is connected to the signal processing circuit 12f2. A magnetic field strength signal Dmg2, which is a detection result detected by the signal processing circuit 12f2, is input from the terminal array SIG2d. The magnetic field strength signal Dmg2 is a signal indicating the intensity of the magnetic field detected by the second magnetic sensor 12h2.

The terminal SIG3 is connected to the polarity detection circuit 12d. A polarity signal Spl, which is a detection result detected by the polarity detection circuit 12d, is input from the terminal SIG3. The polarity signal Spl is a signal indicating the power generation polarity of the power generation element 12g.

The encoder 12 counts the number of rotations of the rotating shaft 11a. The control circuit 12p counts the number of rotations of the rotating shaft 11a using the magnetic pole signal Smg1 and the polarity signal Spl. The control circuit 12p uses the magnetic pole signal Smg1 and the polarity signal Spl to detect which of the regions in which the rotating shaft 11a is divided every 90 degrees is the current region. Then, the control circuit 12p stores the result of counting the number of rotations of the rotating shaft 11a and the result of detecting which is the current region in the storage 12r. The control circuit 12p also stores the magnetic pole signal Smg1, the magnetic pole signal Smg2, and the polarity signal Spl that were last detected in the storage 12r.

The control circuit the 12p obtains rotation angle of the rotating shaft 11a using the magnetic field strength signal Dmg1 and the magnetic field strength signal Dmg2. For example, the control circuit 12p calculates the rotation angle of the rotating shaft 11a using the inverse tangent function from the ratio of the magnetic field strength signal Dmg1 to the magnetic field strength signal Dmg2.

[Storage 12r]

The storage 12r stores, for example, rotation counts and the like. The storage 12r is, for example, a ferroelectric memory. The control circuit 12p stores, in the storage 12r, at least a count value indicating the number of rotations of the rotating shaft 11a, the position of the rotating shaft, and the magnetic pole signal Smg1, the magnetic pole signal Smg2, and the polarity signal Spl that were last detected.

### <Configuration of Encoder>

The configuration of the encoder 12 will be described in detail. A magnet in the encoder 12 will be described.

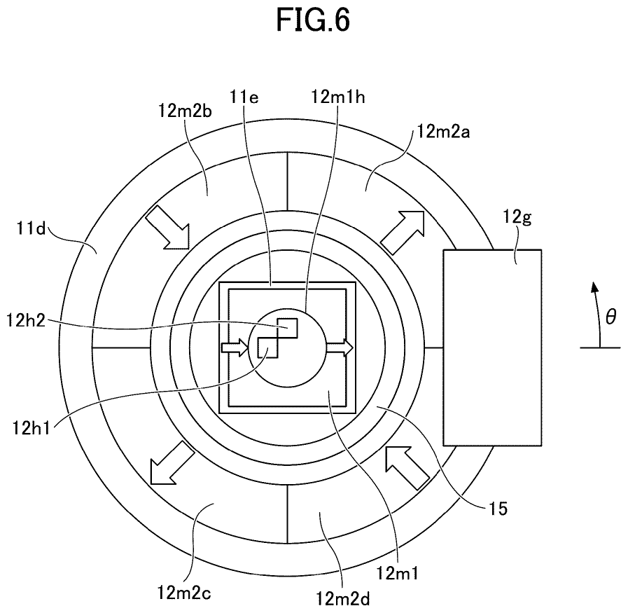

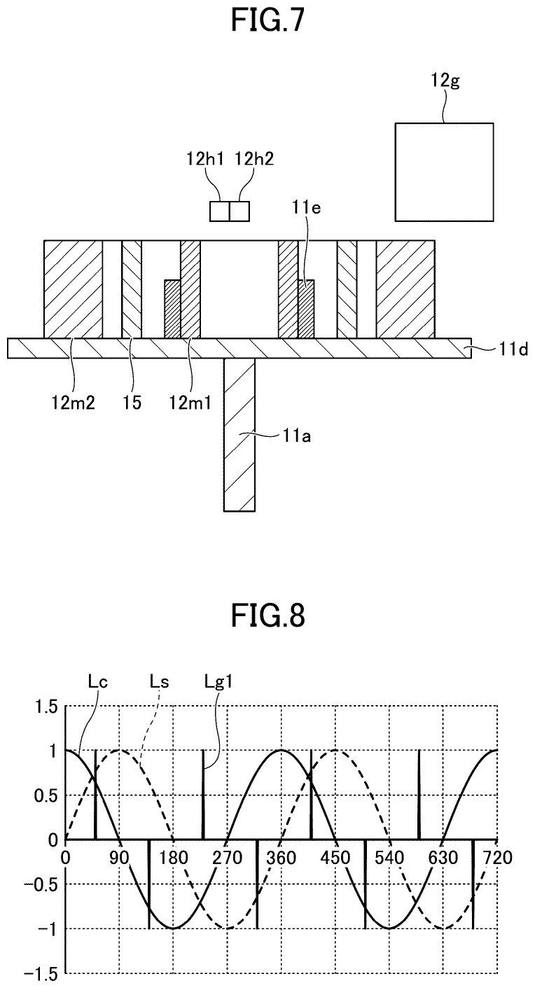

A magnet provided in the encoder 12 will be described. FIG. 6 is a plan view for explaining the configuration of a magnet in the encoder 12 as an example of the encoder according to the first embodiment. FIG. 7 is a sectional view for explaining the configuration of a magnet in the encoder 12 as an example of the encoder according to the first embodiment. In FIG. 6, the direction of the magnetic flux is indicated by an arrow to indicate the polarity of the magnet. The disk 11d is fixed to the rotating shaft 11a and rotates in synchronization with the rotation of the rotating shaft 11a. FIG. 6 is a diagram showing the arrangement of the magnets at a certain point in time. The rotating shaft 11a extends in a direction perpendicular to the sheet in FIG. 6 (see FIG. 7). In FIG. 6, a counterclockwise angle θ is shown.

The encoder 12 includes a rotationally symmetric first magnet 12m1 provided on the disk 11d and a rotationally symmetric second magnet 12m2 provided outside the rotating shaft of the first magnet 12m1. The first magnet 12m1 has two poles of an S pole and an N pole, and is a one-fold rotationally symmetric magnet. In this embodiment, the second magnet 12m2 has four poles, and is a two-fold rotationally symmetric magnet. By making the first magnet 12m1 and the second magnet 12m2 rotationally symmetric in this way, the rotational torque (moment) becomes smaller than that of a rotationally asymmetric magnet, and the load on the motor 11 is reduced.

The encoder 12 has a magnetic material 15 between the first magnet 12m1 and the second magnet 12m2. By providing the magnetic material 15, the encoder 12 can prevent the magnetic forces of the first magnet 12m1 and the second magnet 12m2 from interfering with each other and weakening the magnetic field.

The encoder 12 includes, as the second magnet 12m2, a unit magnet 12m2a, a unit magnet 12m2b, a unit magnet 12m2c, and a unit magnet 12m2d each having a C-shape. The second magnet 12m2 is a magnet formed by combining the unit magnet 12m2a, the unit magnet 12m2b, the unit magnet 12m2c, and the unit magnet 12m2d each having a C-shape in a ring shape. The second magnet 12m2 is provided integrally in the circumferential direction. By being provided integrally in the circumferential direction with the second magnet 12m2, the area efficiency and volume efficiency of generating a magnetic field by the second magnet 12m2 can be improved. By improving the area efficiency and volume efficiency of generating a magnetic field by the second magnet 12m2, the power generation efficiency of the power generation element 12g can be improved.

Although the second magnet 12m2 includes four unit magnets, the number of unit magnets is not limited to four. The second magnet may be a combination of 2×n (n is an integer of one or more) unit magnets having a C-shape.

The unit magnet 12m2a, the unit magnet 12m2b, the unit magnet 12m2c, and the unit magnet 12m2d each have a magnetization direction in a direction perpendicular to the rotating shaft axial direction (a direction parallel to the sheet in FIG. 6).

When the second magnet 12m2 is constituted by combining unit magnets having a C-shape, the magnets can be easily assembled. For example, when the magnets are assembled, assembly work may be difficult due to attraction or repulsion of the magnets. According to the encoder 12, assembly can be facilitated by combining unit magnets having a C-shape and providing them continuously in the circumferential direction. Further, according to the encoder 12, by combining unit magnets having a C-shape and providing them continuously in the circumferential direction, the area efficiency and volume efficiency for generating a magnetic field can be improved as compared with the case where magnets are distributed in the circumferential direction. C-shaped unit magnets are widely distributed, inexpensive, and readily available.

The first magnet 12m1 is a two-pole square magnet with a through hole. A square holder 11e having an inner shape substantially the same size as the outer shape of the first magnet 12m1 is integrally formed on the disk 11d, and the first magnet 12m1 is fitted inside the holder 11e and fixed with an adhesive. The first magnet 12m1 has a through hole 12m1h.

The first magnet 12m1 has a magnetization direction aligned with a direction in which a magnetic field of the second magnet 12m2 is zero, that is, in the direction between adjacent unit magnets, more specifically, in the direction between the unit magnet 12m2a and the unit magnet 12m2d.

Since the first magnet 12m1 is a square magnet, the magnetization direction of the first magnet 12m1 can be easily aligned by simply fitting the first magnet 12m1 into the holder 11e formed on the disk 11d. Note that the holder 11e does not need to surround the entire periphery of the first magnet 12m1, but may have a shape in which the magnetization direction of the first magnet 12m1 can be determined, such as a shape in which two corners of the square magnet can be positioned.

In the above example, the second magnet is a combination of unit magnets having a C-shape, but the second magnet may be a ring magnet having 2×n poles (n is an integer of one or more). The ring magnet is easier to manufacture and assemble on the disk 11d than a combination of C-shaped unit magnets.

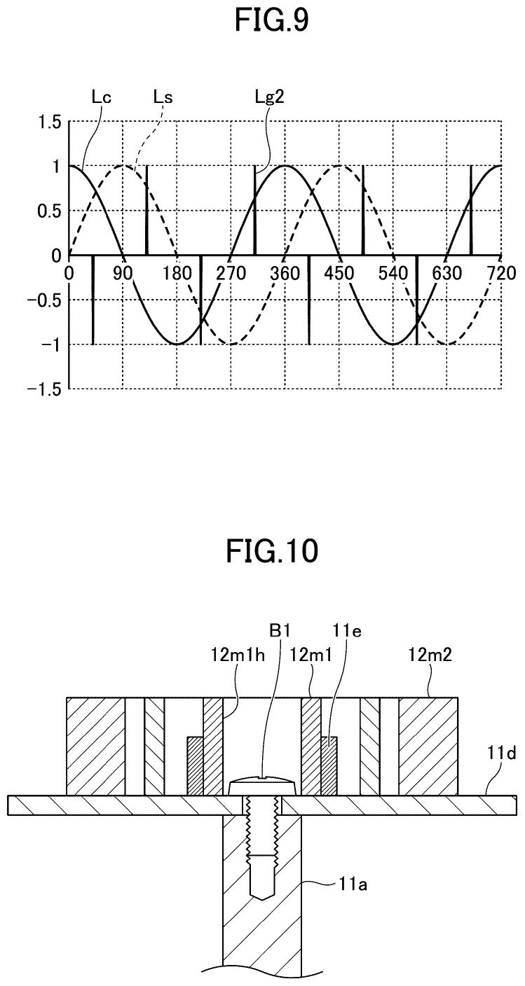

Next, a signal waveform in the encoder 12 will be described. FIGS. 8 and 9 are diagrams for explaining a signal waveform in the encoder 12, which is an example of the encoder according to the first embodiment. FIG. 8 shows waveforms when the first magnet 12m1 and the second magnet 12m2 rotate counterclockwise in FIG. 6. FIG. 9 shows waveforms when the first magnet 12m1 and the second magnet 12m2 rotate clockwise in FIG. 6.

Assume that the first magnetic sensor 12h1 has a magnetic sensitivity direction the horizontal direction in FIG. 6, and the second magnetic sensor 12h2 has a magnetic sensitivity direction in the vertical direction in FIG. 6.

In FIGS. 8 and 9, the horizontal axis indicates the angle θ, and the vertical axis indicates the signal intensity normalized so that the maximum is 1. The line Lc indicates the signal output from the first magnetic sensor 12h1, the line Ls indicates the signal output from the second magnetic sensor 12h2, the line Lg1 indicates the signal generated by the power generation element 12g in the counterclockwise direction, and the line Lg2 indicates the signal generated by the power generation element 12g in the clockwise direction.

As shown in FIGS. 8 and 9, the magnetic field generated by the first magnet 12m1 causes the first magnetic sensor 12h1 and the second magnetic sensor 12h2 to output sine waves which are out of phase by 90 degrees. In addition, the power generation element 12g generates power in proximity to an angle which is a multiple of 45 degrees. The polarity of power generation varies depending on the direction of rotation. The polarity of power generation when rotating counterclockwise is opposite to the polarity of power generation when rotating clockwise. Since the power generation characteristic of the power generation element 12g has hysteresis, the angle at which the power generation element 12g generates power is deviated from an angle which is a multiple of 45 degrees. The direction of deviation when rotating counterclockwise is opposite to the direction of deviation when rotating clockwise.

As shown in FIGS. 8 and 9, since the first magnetic sensor 12h1 and the second magnetic sensor 12h2 output power and the power generation element 12g generates power, the encoder 12 can measure the rotational direction and the rotational position with an angular resolution of 90 degrees.

The attachment of the magnets will be described. FIG. 10 is a sectional view for explaining the configuration of the encoder 12, which is an example of the encoder according to the first embodiment. The first magnet 12m1 and the second magnet 12m2 are fixed to the disk 11d by an adhesive. The disk 11d is fixed to a bolt hole provided in the rotating shaft 11a by a bolt B1. The encoder 12 includes the first magnet 12m1, which is a square magnet with a through hole. By fixing the bolt B1 through the through hole in the first magnet 12m1, the disk 11d in which the first magnet 12m1 and the second magnet 12m2 are attached can be easily attached to the rotating shaft 11a. By fixing the bolt B1 through the through hole in the first magnet 12m1, the disk 11d can be easily replaced.

According to the above embodiment, the first magnet 12m1 has the through hole 12m1h, but the through hole 12m1h may be omitted. That is, the first magnet 12m1 may be a square magnet without the through hole. In other words, the first magnet 12m1 may be a square magnet. In this case, when the first magnet 12m1 is attached, a square magnet having no through hole is fixed to the bolt head of the bolt B1 with an adhesive.

In the above embodiment, the unit magnet 12m2a, the unit magnet 12m2b, the unit magnet 12m2c, and the unit magnet 12m2d each have a magnetization direction in a direction perpendicular to the rotating shaft axial direction (a direction parallel to the sheet in FIG. 6), but the magnetization direction of the unit magnets 12m2a to 12m2d may be along the rotating shaft axial direction (a direction perpendicular to the sheet in FIG. 6).

### Second Embodiment

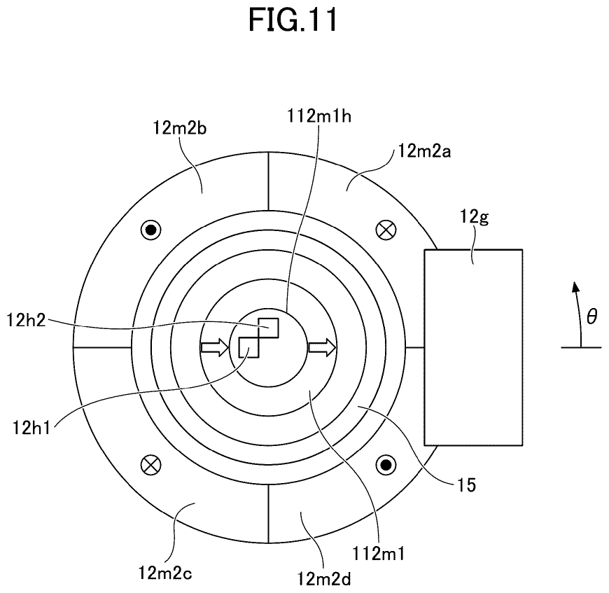

An encoder according to a second embodiment will be described. A magnet in an encoder according to a second embodiment will be described. FIG. 11 is a plan view describing the configuration of the magnet in the encoder according to a second embodiment. In FIG. 11, the direction of the magnetic flux is indicated by an arrow to indicate the polarity of the magnet. In FIG. 11, the magnetic field perpendicular to the sheet is indicated by a black circle in a circle for a magnetic field facing toward the front, and by a cross in a circle for a magnetic field facing toward the back. Since the disk 11d rotates in synchronization with the rotation of the rotating shaft, FIG. 11 is a diagram showing the arrangement of the magnets at a certain point in time. The rotating shaft extends in the direction perpendicular to the sheet in FIG. 11. In FIG. 11, the counterclockwise angle θ is shown.

The encoder according to the second embodiment includes a rotationally symmetric first magnet 112m1 provided on the disk 11d, and a rotationally symmetric second magnet 112m2 provided outside with respect to the rotating shaft of the first magnet 112m1. The encoder according to the second embodiment also includes a magnetic material 15 between the first magnet 112m1 and the second magnet 112m2. By including the magnetic material 15, the encoder according to the second embodiment can prevent the magnetic forces of the first magnet 112m1 and the second magnet 112m2 from interfering with each other and weakening the magnetic field.

The encoder according to the second embodiment includes, as the second magnet 112m2, a unit magnet 112m2a having a C-shape, a unit magnet 112m2b, a unit magnet 112m2c, and a unit magnet 112m2d. The second magnet 112m2 is a magnet obtained by combining a unit magnet 112m2a, a unit magnet 112m2b, a unit magnet 112m2c, and a unit magnet 112m2d each having a C-shape.

In this embodiment, the unit magnet 112m2a, the unit magnet 112m2b, the unit magnet 112m2c, and the unit magnet 112m2d each have a magnetization direction in the rotating shaft axial direction (a direction perpendicular to the sheet in FIG. 6), but the magnetization direction may be a direction perpendicular to the rotating shaft axial direction (a direction parallel to the sheet in FIG. 6).

When the second magnet 112m2 is composed of a combination of unit magnets having a C-shape, the magnets can be easily assembled.

The first magnet 112m1 is a two-pole ring magnet. The first magnet 112m1 has a through hole 112m1h. The first magnet 112m1 may be a two-pole cylindrical magnet.

When the first magnet 112m1 has a ring shape or a cylinder shape, the magnetic flux distribution becomes uniform in the circumferential direction as compared with the square shape. As a result, distortion does not occur in the two-phase signals of the first magnetic sensor 12h1 and the second magnetic sensor 12h2, and the effect of reducing the angular error can be obtained.

The first magnet 112m1 has a magnetization direction aligned with a direction in which a magnetic field of the second magnet 112m2 is zero, that is, in the direction between adjacent unit magnets, more specifically, in the direction between the unit magnet 112m2a and the unit magnet 112m2d.

In the above example, the second magnet is a combination of unit magnets having a C-shape, but the second magnet may be a ring magnet having 2×n poles (n is an integer of one or more). The ring magnet is easier to manufacture and assemble than a combination of C-shaped unit magnets.

### Third Embodiment

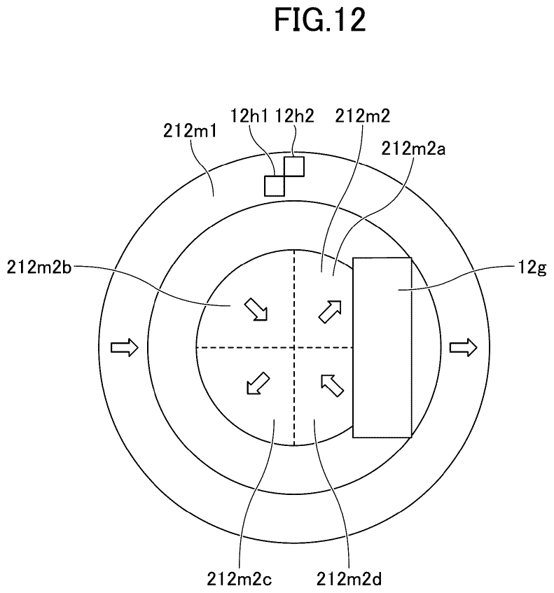

An encoder according to a third embodiment will be described. A magnet in the encoder according to the third embodiment will be described. FIG. 12 is a plan view describing the configuration of the magnets in the encoder according to a third embodiment. In FIG. 12, the direction of the magnetic flux is indicated by an arrow to indicate the polarity of the magnet. Since the disk 11d rotates in synchronization with the rotation of the rotating shaft, FIG. 12 is a diagram showing the arrangement of the magnets at a certain point in time. The first magnetic sensor 12h1, the second magnetic sensor 12h2, and the power generation element 12g are mounted on a circuit board.

The encoder according to the third embodiment includes a rotationally symmetric second magnet 212m2 provided on the disk 11d, and a rotationally symmetric first magnet 212m1 provided outside the rotating shaft of the second magnet 212m2. The magnetic material 15 may be provided between the first magnet 212m1 and the second magnet 212m2.

The first magnet 212m1 is a two-pole ring magnet. The second magnet 212m2 is provided inside the first magnet 212m1.

The encoder according to the third embodiment includes, as the second magnet 212m2, a unit magnet 212m2a, a unit magnet 212m2b, a unit magnet 212m2c, and a unit magnet 212m2d each having a fan shape. The second magnet 212m2 is a combination of a unit magnet 212m2a, a unit magnet 212m2b, a unit magnet 212m2c, and a unit magnet 212m2d each having a fan shape.

In this embodiment, each of the unit magnets 212m2a, 212m2b, 212m2c, and 112m2d has a magnetization direction in a direction perpendicular to the rotating shaft axial direction (a direction parallel to the paper surface in FIG. 6), but the magnetization direction may be a direction perpendicular to the rotating shaft axial direction (a direction parallel to the paper surface in FIG. 6).

When the second magnet 212m2 is constituted by combining the unit magnets having a fan shape, the magnets can be easily assembled.

The first magnet 212m1 has a magnetization direction aligned with a direction in which a magnetic field of the second magnet 212m2 is zero, that is, a direction between adjacent unit magnets, more specifically, a direction between the unit magnet 212m2a and the unit magnet 212m2d.

Further, the present invention is not limited to these embodiments, but various variations and modifications may be made without departing from the scope of the present invention.

What is claimed is:

1. An encoder comprising:
a power generation element;
magnetic sensors;
a first magnet which is rotationally symmetric, rotates on a rotating shaft, and is provided near the magnetic sensors; and
a second magnet which is rotationally symmetric, rotates on the rotating shaft, is provided near the power generation element, and is continuously provided in a circumferential direction.

2. The encoder according to claim 1, wherein the second magnet is a combination of 2×n unit magnets having a C-shape, wherein n is an integer of one or more.

3. The encoder according to claim 1, wherein the second magnet is a ring magnet having 2×n poles, wherein n is an integer of one or more.

4. The encoder according to claim 1, wherein the first magnet is a two-pole cylindrical magnet.

5. The encoder according to claim 1, wherein the first magnet is a two-pole square magnet.

6. The encoder according to claim 1, wherein the first magnet is a two-pole ring magnet.

7. The encoder according to claim 1, wherein the first magnet is a two-pole square magnet with a through hole.

8. The encoder according to claim 1, wherein the magnetic sensors have magnetic sensitivity directions that are 90 degrees out of phase with each other.

9. The encoder according to claim 1, wherein a magnetic material is provided between the first magnet and the second magnet.

10. The encoder according to claim 1, wherein the first magnet has a magnetization direction aligned with a direction in which a magnetic field of the second magnet is zero.
